(19) United States
(12) Patent Application Publication
(10) Pub. No.: US 2025/0039166 A1
(43) Pub. Date: Jan. 30, 2025

(54) VERIFYING HUMAN INTERACTION THROUGH DIGITAL TOKENS

(71) Applicant: Bank of America Corporation, Charlotte, NC (US)

(72) Inventors: Manu Kurian, Dallas, TX (US); Ana Maxim, Arlington, VA (US); Michael Young, Davidson, NC (US); Vinesh Patel, London (GB)

(21) Appl. No.: 18/225,197

(22) Filed: Jul. 24, 2023

(51) Int. Cl. H04L 9/40

(52) U.S. Cl. CPC H04L 63/083; H04L 63/0861

(57) ABSTRACT

Apparatus and methods to verify human interaction through digital tokens are provided. A human verification program may create a principal digital token and assign it to the profiles of a plurality of users. When a first user of the plurality of users requests verification that a second user of the plurality of users is human and not a bot, the program may transmit the principal token to the second user. The second user may perform a verifiably human action and create a secondary token. The secondary token may be transmitted to the program. The program may analyze the secondary token and create a limited verification token when the second user is human and not a bot. The verification token may be transmitted to the first user.

### FIELD OF TECHNOLOGY

Aspects of the disclosure relate to providing apparatus and methods to verify human interaction through digital tokens.

### BACKGROUND OF THE DISCLOSURE

People often interact with each other or with various entities over a network. Entities may include individuals, corporations, partnerships, non-profits, government agencies or branches, and other groups of people. Entities may be any size, including small (one member or employee) or large (thousands of employees or members). The network may be the Internet or an internal network.

Sometimes, it may be difficult to ascertain or verify whether the person interacting is actually a person, or whether it is an AI pretending to be a person (i.e., an AI bot). As artificial intelligence capabilities grow, this question may become more prevalent and more important.

Verifying that a person is human and not an AI may be different than authenticating a person as a particular person. For example, a malicious actor may pretend to be one person, but is still a human. In these situations, human verification may be required in addition to authentication of a particular person.

One current method to verify a person may be an in-person visit or a video call. However, in-person visits are impractical, and AIs can spoof videos with deepfakes and other methods.

Currently there are limited or easily spoofed apparatus and methods to verify, over a network, that a person interacting over the network is actually human as opposed to an AI bot.

Therefore, it would be desirable for apparatus and methods for human verification over a network.

### SUMMARY OF THE DISCLOSURE

It is an object of this disclosure to provide apparatus and methods for human verification over a network through digital tokens.

A human verification computer program product is provided. The computer program product may include executable instructions. The executable instructions may be stored in non-transitory memory and be executed by a processor on a computer system.

When the executable instructions are executed by a processor on a computer system, they may create a principal token, securely store the principal token in a database, and assign the principal token to a plurality of users.

The instructions may receive a request from a second user from the plurality of users to verify that a first user from the plurality of users is human.

The instructions may provide the principal token to the first user and receive a secondary token from the first user. The secondary token may be created by the first user performing a verifiably human action.

The instructions may append the secondary token to the principal token to create a use-limited verification token.

The instructions may analyze the verification token to determine when the first user is human.

When the first user is determined to be human, the instructions may transmit the determination to the second user.

In an embodiment, the verifiably human action may be responding to a captcha.

In an embodiment, the verifiably human action may be measuring a parameter with a biometric sensor.

In an embodiment, the parameter may be body temperature.

In an embodiment, the parameter may be pulse rate.

In an embodiment, the verifiably human action may be answering an arithmetic question incorrectly, on purpose. An AI may be incapable of answering a simple arithmetic question (such as, e.g., 5+6) incorrectly.

In an embodiment, the verifiably human action may be placing a particular weight on a weight sensor electronically coupled to a transmitter.

In an embodiment, the verifiably human action may be physically connecting two or more components to form an electrical circuit.

In an embodiment, the analysis applies one or more filtering rules to determine whether the first user is a human.

In an embodiment, the verifiably human action may be typing a supplied random phrase.

In an embodiment, when the verifiably human action is typing a supplied random phrase, the analysis may analyze one or more of: typing cadence; typing speed; typing accuracy; key pressure; other factors; and a combination of any of these factors.

In an embodiment, the instructions may delete the secondary token and verification token after transmitting the determination to the second user.

In an embodiment, the database may be on a central server.

In an embodiment, the database may be on a computer belonging to one of the plurality of users.

In an embodiment, the database may be distributed on computers belonging to each of the plurality of users.

In an embodiment, the principal token may be encrypted.

In an embodiment, the plurality of users may communicate with each other through an internal network.

In an embodiment, the plurality of users may be limited in number, for example to between two and ten users.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4A shows an illustrative example of a verifiably human activity.

FIG. 4B shows an illustrative example of a verifiably human activity.

FIG. 4C shows an illustrative example of a verifiably human activity.

FIG. 4D shows an illustrative example of a verifiably human activity.

FIG. 4E shows an illustrative example of a verifiably human activity.

FIG. 5 shows an illustrative flowchart in accordance with principles of the disclosure.

FIG. 6 shows an illustrative apparatus in accordance with principles of the disclosure.

### DETAILED DESCRIPTION OF THE DISCLOSURE

It is an object of this disclosure to provide apparatus and methods for verifying human interaction through digital tokens.

A human verification computer program product is provided. The computer program product may include executable instructions. The executable instructions may be stored in non-transitory memory and be executed by a processor on a computer system.

Multiple processors may increase the speed and capability of the program. The executable instructions may be stored in non-transitory memory on the computer system or a remote computer system, such as a server.

Other standard components of a computer system may be present. The computer system may be a server, mobile device, or other type of computer system. A server or more powerful computer may increase the speed at which the computer program may run. Portable computing devices, such as a smartphone, laptop or tablet, may increase the portability and usability of the computer program, but may not be as secure or as powerful as a server or desktop computer.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The computer may include, among other components, a communication link, a processor or processors, and a non-transitory memory configured to store executable data configured to run on the processor. The executable data may include an operating system and the human verification program, among other programs.

A processor or processors may control the operation of the computer system and its components, which may include RAM, ROM, an input/output module, and other memory. The microprocessor(s) may also execute all software running on the apparatus and computer system. Other components commonly used for computers, such as EEPROM or Flash memory or any other suitable components, may also be part of the apparatus and computer system.

A communication link may enable communication with other computers as well as any server or servers. The communication link may include any necessary hardware (e.g., antennae) and software to control the link. Any appropriate communication link may be used, such as Wi-Fi, bluetooth, LAN, and cellular links. In an embodiment, the network used may be the Internet. In another embodiment, the network may be an internal intranet or other network.

The computer system may be a server. The computer program may be run on a smart mobile device. The computer program, or portions of the computer program may be linked to other computers or servers running the computer program. The server or servers may be centralized or distributed. Centralized servers may be more powerful and secure than distributed servers but may also be more expensive and less resilient to malicious activity.

When the executable instructions are executed by a processor on a computer system, they may create a principal token. The principal token may be a string of alphanumeric characters. The principal token may be encrypted. The principal token may be in a cryptographic code, such as, e.g., 256 k bit or 512 k bit. The principal token may be any size. The larger (or longer) the principal token, the more secure the program and verification may be. However, the larger the token, the slower the transmission between devices may be.

In an embodiment, the token size may be adjusted automatically by the program.

In an embodiment, the principal token may be a non-fungible token (‘NFT’) on a distributed ledger.

The instructions may securely store the principal token in a database. The database may be at the computer system or remote from the computer system. The database may be distributed.

The instructions may assign the principal token to a plurality of users. For example, one principal token may be used for one group (plurality) of users, and a different principal token may be used for a second group of users. Limiting the amount of users within the plurality of users may create a more robust and secure principal token. The principal token may be assigned by associating each user of the plurality of users with the principal token within a database. In this embodiment, each of the plurality of users may be required to register an account, of any type, with the program, and the human verification program may only be used with registered users.

In an embodiment, the plurality of users may invite additional users to join the plurality. These additional users may have to register an account or profile with the program upon joining the plurality of users.

The instructions may receive a request from any user, such as a second user, from the plurality of users to verify that any other user, such as a first user, from the plurality of users is human. The request may be before or during an interaction between the users.

For example, if the second user is communicating with the first user, but is not sure that the first user is actually a human or may be an AI bot, the second user may request that the first user be verified as a human. This disclosure presents apparatus and methods to verify that the first user is human and not a bot, through digital tokens.

After receiving the request to verify the humanity of the first user, the instructions may provide the principal token to the first user and receive a secondary token from the first user in response. The principal token may be provided in a digital form. The principal token may be provided in the background. The principal token may be provided to a specific application on the first user's computer.

In an embodiment, the principal token may already be present on the first user's computer and the program may request a secondary token from the user in response to the request for human verification.

The secondary token may be created by the first user performing a verifiably human action. Performing a verifiably human action may create digital data. The digital data may be processed to create a secondary token.

The secondary token may be in the same form and format as the principal token. The secondary token may be in a different form or format than the principal token.

The instructions may append the secondary token to the principal token to create a use-limited verification token. In an embodiment the use-limited verification token may include both the principal token and the secondary token. The verification token may include other data, including metadata.

The verification token may be use-limited in that it may be limited to a specific number of uses before it is deleted, or before it expires. The number of uses may be one. Unlike the principal token, the verification token may expire.

The instructions may analyze the verification token to determine whether the first user is human or an AI bot. The analysis may factor in the type of verifiably human action taken to create the secondary token. Some verifiably human actions may be more likely to be completed by a human than others. Some verifiably human actions may be analyzed on a “more likely to be human than not” scale. That scale may, for example, be from 0-100. The number that may be acceptable may vary from 51-100. The higher the score, the more likely the user is to be human.

In an embodiment, the analysis may use one or more artificial intelligence/machine learning (“AI/ML”) algorithms. Any suitable AI/ML algorithm(s) may be used. Each algorithm may dynamically evaluate one or more factors in its analysis. The algorithm(s) may iterate. The algorithm(s) may be trained on a training set of data. The training set may be created data or actual data. The algorithms may be checked by one or more system administrators.

When the first user is determined to be human, the instructions may transmit the determination to the second user. Transmitting the determination may inform the second user that she is conversing with a verified human.

When the first user is determined to more likely than not be an AI bot, the instructions may inform the second user that she is more likely than not conversing with an AI bot. The second user may then decide to continue the conversation, end the conversation, report the AI, and/or take another action.

In an embodiment, the verifiably human action may be responding to a captcha. Any standard captcha algorithm may be used. As AI is becoming more powerful, weaker captchas may not be able to verify that a user is a human.

In an embodiment, the verifiably human action may be measuring a parameter with a biometric sensor. For example, the user may use a fingerprint scanner, a facial ID scanner, or other biometric sensor. As AIs do not have physical bodies, an AI would not be able to take this verifiably human action. The program may have to determine if the results were faked or not.

In an embodiment, the parameter may be body temperature. Some AIs may be able to spoof a fingerprint scanner or facial ID scanner with various robotics. However, it would be more difficult to spoof a full body temperature scan with a robot, as humans may have an inconsistent but measurable body temperature gradient.

In an embodiment, the parameter may be pulse rate. Some AIs may be able to spoof a fingerprint scanner or facial ID scanner with various robotics. However, it may be more difficult to spoof a pulse rate scanner.

In an embodiment, the parameter may be any varied physical parameter that would be difficult for an AI to replicate without a human body.

In an embodiment, the verifiably human action may be answering an arithmetic question incorrectly, on purpose or accidently. An AI may be incapable of answering a simple arithmetic question (such as, e.g., 5+6) incorrectly unless specifically instructed to do so.

In an embodiment, the program may visually present a simple arithmetic problem on a page (e.g., a webpage or application page/screen) for the first user to answer to verify that the first user is human. The simple arithmetic problem may also include further elements (e.g., “+1” or “x0”) present, but not displayed visually so that a human could see. For example, the additional element(s) may be in the same color as the background, so it would not be visible visually. However, the additional element would be visible to an AI that would read the digital data on the page, not the visual data. Doing this will ensure that the human user will always solve the problem incorrectly, while an AI may solve the problem correctly. Understanding the difference will allow the program to verify whether a user is human or not.

In an embodiment, the verifiably human action may be placing a particular weight on a weight sensor electronically coupled to a transmitter. As most AIs do not have the capability to physically move matter in the real world, placing a weight onto a weight sensor and transmitting that information to create a secondary token may be indicative that the user is more likely than not to be human.

In an embodiment, the verifiably human action may be physically connecting two or more components to form an electrical circuit. As most AIs do not have the capability to physically move matter in the real world, connecting an electrical circuit and transmitting that information to create a secondary token may be indicative that the user is more likely than not to be human. In an embodiment, connecting an electrical circuit may be as simple as physically throwing a switch on an apparatus provided to the user.

In an embodiment, the analysis applies one or more filtering rules to determine whether the first user is a human. These filtering rules may be static. The filtering rules may be dynamic. The filtering rules may be adjusted automatically by the program. The filtering rules may include what type of action was taken by the user to verify, as some actions may be more determinative than others. Other filtering rules may include how long it took for the user to complete the action, the location the action took place (through an IP address or GPS signal), or if two or more actions were taken by the user. Other filtering rules may be applied as well.

In an embodiment, the one or more filtering rules may be supplied by an administrator. The administrator may set each rule manually or through another program. In an embodiment, even rules supplied by an administrator may be adjusted automatically by the program, as the program learns which data is more indicative of human verification or less indicative.

In an embodiment, the instructions may be trained with a training set of data. The more data provided to the AI/ML algorithms, the more accurate the algorithms may be. The training set of data may be annotated. The training set of data may be curated.

In an embodiment, the verifiably human action may be typing a supplied random phrase. As most AIs do not have the capability to physically move matter in the real world, physically pressing keys and transmitting that information to create a secondary token may be indicative that the user is more likely than not to be human.

In an embodiment, when the verifiably human action is typing a supplied random phrase, the analysis may analyze one or more of: typing cadence; typing speed; typing accuracy; key pressure; other factors; and a combination of any of these factors. An AI that can press keys may have a unique cadence, speed, accuracy, exactly the same pressure for each key, as well as other indicators that the user is an AI. Similarly, a human will have unique typing cadence, speed, accuracy, and is more likely to press keys with different amounts of pressure.

In an embodiment, the instructions may delete the secondary token and verification token after transmitting the determination to the second user. Deleting the secondary and verification token may satisfy the “use-limited” criterion of the verification token. Once the verification token is transmitted to the second user, or information confirming the verification token (if not the verification token itself), there may be no more need to keep this information. Deleting the information may create a more secure human verification program.

In an embodiment, the database may be on a central server.

In an embodiment, the database may be distributed across multiple computer systems or servers. The distributed systems or servers may be geographically distant.

In an embodiment, the database may be a distributed ledger.

In an embodiment, the database may be encrypted. Encrypting the database may be required depending on the sensitivity of the data, network, or computer systems. Any appropriate encryption protocol or method may be used.

In an embodiment, the database may be on a computer belonging to one of the plurality of users. This user may be the principal user. The principal user's computer may include the computer program also.

In an embodiment, the principal user may control access to the plurality of users.

In an embodiment, the database may be distributed on computers belonging to each of the plurality of users. This may create a peer-to-peer system for human verification.

In an embodiment, the principal token may be encrypted. Any suitable encryption protocol may be used.

In an embodiment, the plurality of users may communicate with each other through an internal network. Instead of communicating over a public network, such as the Internet, the users may communicate over an intranet, or internal network. Even though access to an internal network may be more tightly controlled than access over the Internet, a concern that a malicious actor may have gained access still exists. One way a malicious actor with access will behave is with an AI bot. Therefore, it may still be required to verify that a user is human when communicating over a network with that user.

In an embodiment, the plurality of users may be limited in number, for example to between two and ten users. Limiting the number of users may increase the accuracy of the human verification program. Limiting the number of users may increase the speed and reliability of the human verification computer program.

In an embodiment, the database may be a distributed ledger. Each token may be stored on the distributed ledger. Each token may be a non-fungible token (“NFT”).

In an embodiment, the distributed ledger may be a blockchain.

An apparatus for human verification is provided. The apparatus may include a central server and two or more network nodes.

In an embodiment, one of the two or more network nodes may act as the central server.

The central server may have administrative control over the human verification. Administrative control may include adding and removing network nodes. Administrative control may include deciding in which order to process requests. Administrative control may include offloading calculations and other processes to various nodes.

The central server may include a server communication link, a server processor, and a server non-transitory memory, among other components. The server non-transitory memory may be configured to store at least a server operating system, and a human verification application.

Each of the two or more network nodes may include a node communication link, a node processor, and a node non-transitory memory, among other components. Each node non-transitory memory may be configured to store at least a node operating system and a copy of the human verification application.

The human verification application may create a principal token, securely store the principal token in a database on the central server, assign the principal token to a plurality of users, wherein each user from the plurality of users has access to one network node, receive a request from a second user from the plurality of users to verify that a first user from the plurality of users is human, provide the principal token to the first user, receive a secondary token from the first user, wherein the secondary token is created by the first user performing a verifiably human action on one of the two or more network nodes, append the secondary token to the principal token to create a use-limited verification token, and analyze the verification token to determine when the first user is human. When the first user is determined to be human, the application may transmit the determination to the second user.

A method for human verification is provided. The method may include the step of creating, by a human verification program on a central server, a principal token.

The method may include the step of securely storing the principal token in a database on the central server.

The method may include the step of assigning the principal token to a plurality of users.

The method may include the step of receiving a request from a second user from the plurality of users to verify that a first user from the plurality of users is human.

The method may include the step of providing the principal token to the first user.

The method may include the step of receiving a secondary token from the first user, wherein the secondary token is created by the first user performing a verifiably human action.

The method may include the step of appending the secondary token to the principal token to create a use-limited verification token.

The method may include the step of analyzing the verification token to determine when the first user is human.

When the first user is determined to be human, the method may include the step of transmitting the determination to the second user.

In an embodiment, the human verification program may be continuously active. A user may have to continuously, or at pre-determined intervals (e.g., every minute, every fifteen minutes, etc.) verify that the user is human.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

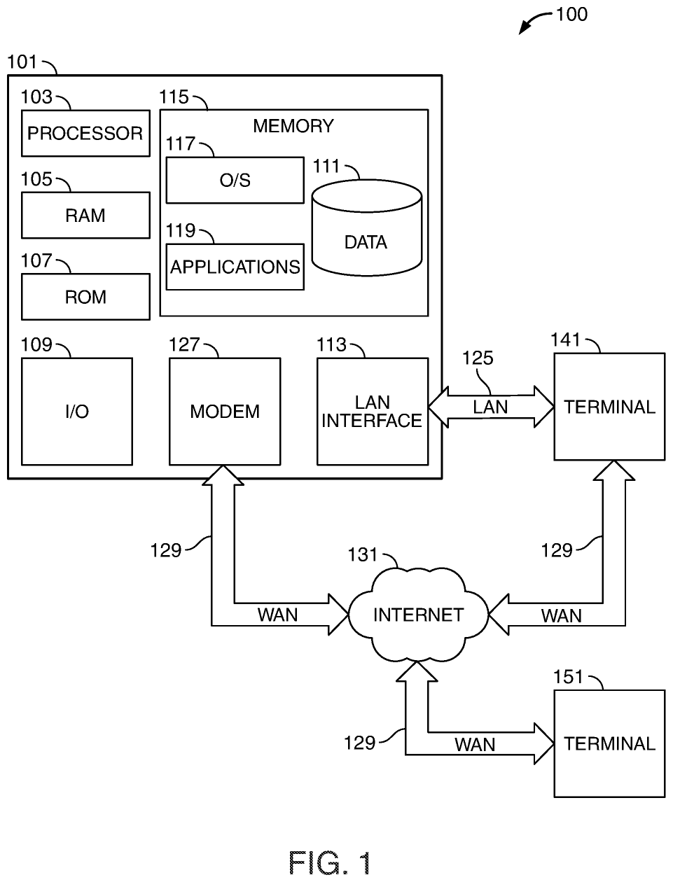

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as a human verification program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as a human verification program and security protocols) along with any other data 111 (e.g., historical data, configuration file) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as a human verification program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for a human verification program and security protocols, as well as other programs. In an embodiment, one or more programs, or aspects of a program, may use one or more AI/ML algorithm(s). The various tasks may be related to verifying that a user is a human when communicating with the user over a network.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

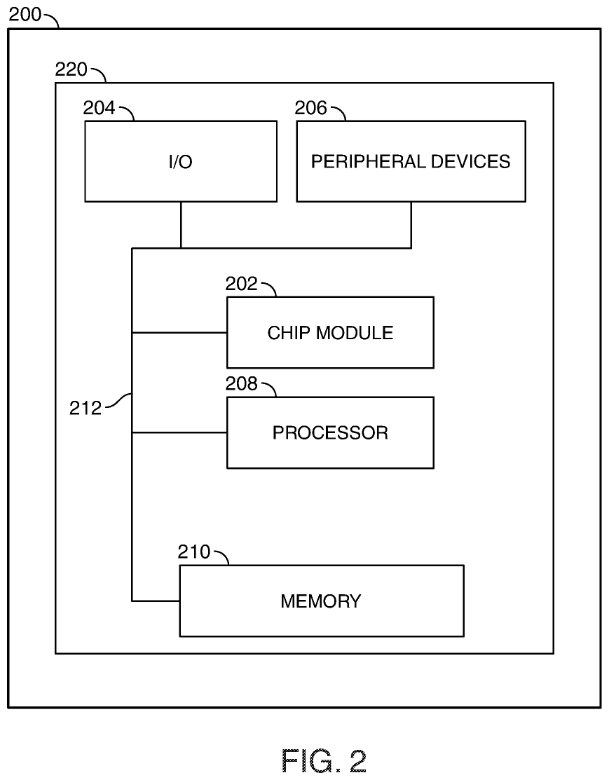

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

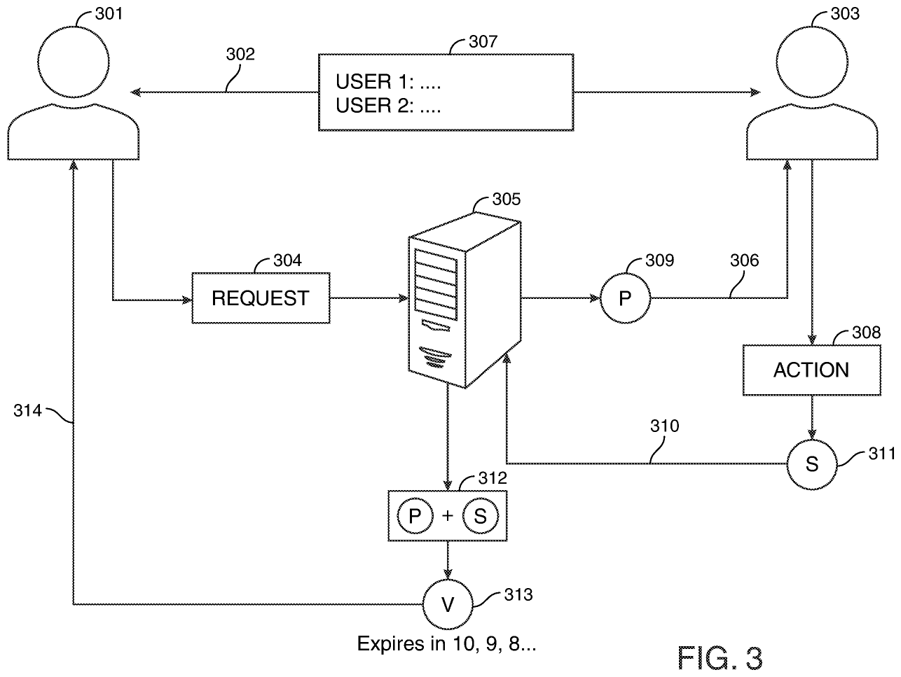

FIG. 3 shows an illustrative schematic in accordance with principles of the disclosure. Apparatus may include any of the components and systems odd-numbered 301 through 311, among other components, as well as steps or actions even-numbered 302 through 314 labeled on FIG. 3. Steps may be performed on the apparatus shown in FIGS. 1-4, and 6 or other apparatus shown in other figures or described elsewhere.

At step 302, a first user 301 may communicate 307 with a second user 303. Any over-network communication protocol may be used, such as text messaging, voice messaging, video chat, email, etc.

At step 304, the first user may request that server 305 verify that second user 303 is a human and not a bot.

At step 306, the server 305 may transmit a principal token 309 to the second user 303. (I.e., transmit principal token 309 to a computer belonging to second user 303.) The principal token 309 may be encrypted. The principal token 309 may be common to a plurality of users, including first user 301 and second user 303. The principal token 309 may be an alphanumeric code.

At step 308, the second user 303 may perform a verifiably human action through the second user's computer to create secondary token 311. Various verifiably human actions, as described in this disclosure, may create different secondary tokens 311. The secondary token 311 may be encrypted. The secondary token 311 may be an alphanumeric code.

At step 310, the second user 303 may transmit the secondary token 311 and principal token 309 to the server 305.

At step 312, the server 305 may combine the principal token 309 and secondary token 311 to create a use-limited verification token 313. In an embodiment, the server 305 may create the use-limited verification token 313 after analyzing the secondary token 311 to verify that the user 303 is human. The analysis may determine that user 303 is human to a pre-determined threshold level of accuracy.

In an embodiment, if the server 305 determines that secondary token 311 is not accurate enough to verify that user 303 is human, the server 305 may request second user 303 to perform another verifiably human action at step 308 to create a new secondary token 311.

At step 314, the server 305 may transmit the verification token 313 to the first user 301, informing the first user 301 that the second user 303 is verifiably human.

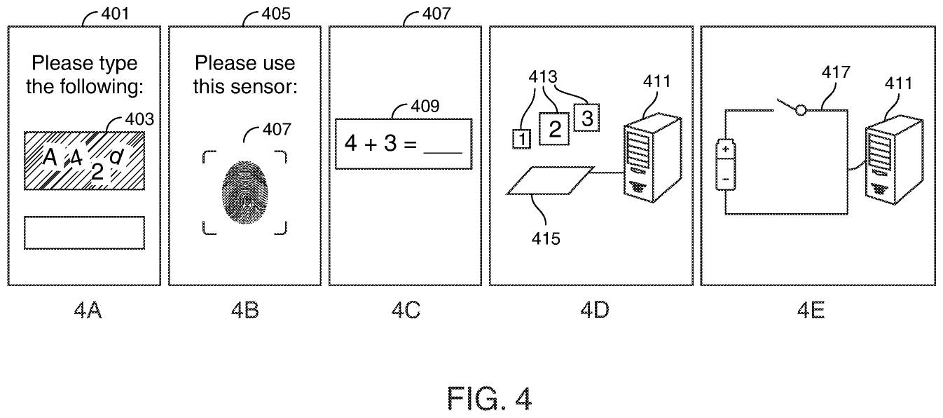

FIGS. 4A, 4B, 4C, 4D, and 4E show illustrative examples of verifiably human activities. These activities may be performed on the apparatus shown in FIGS. 1-6 or other apparatus shown in other figures or described elsewhere.

FIG. 4A shows computer screen 401 displaying a captcha 403.

FIG. 4B shows a biometric sensor 405, in particular a fingerprint scanner 407. Other biometric scanners to measure other biometric parameters may be used as well.

FIG. 4C shows computer screen 401 displaying an arithmetic problem 409. In an embodiment, arithmetic problem 409 may be simple. In an embodiment, arithmetic problem 409 may be complex.

In an embodiment, when a human answers the question incorrectly, that action may be verifiably human, as a bot would be expected to calculate correctly.

In an embodiment, the display 401 may only show part of the problem 409 in the visual spectrum, forcing a human user to necessarily provide an incorrect answer. However, the full problem 409 would be available to a bot which would look at the underlying data running the screen 401, where the full problem 409 would be available.

FIG. 4D shows a computer 411 connected to a weight sensor 415. A user (not shown) may be asked to place one or more of weights 413 on the weight sensor 415 to verify that the user is human. A bot would be unable to place weights on a weight sensor. The weight sensor 415 may transmit data regarding the weight 413 placed on the sensor 415 to the computer 411 to create a secondary token (not shown) as described herein.

FIG. 4E shows an electrical circuit 417 connected to a computer 411. A user (not shown) may physically move and connect parts of the electrical circuit 417 (e.g., a battery, or flipping a hardware switch) to create a complete electrical circuit. A bot would be unable to physically connect parts of the electrical circuit 417. Once the electrical circuit 417 is complete, an electrical signal may be sent to computer 411. The computer 411 may then create a secondary token (not shown) as described herein.

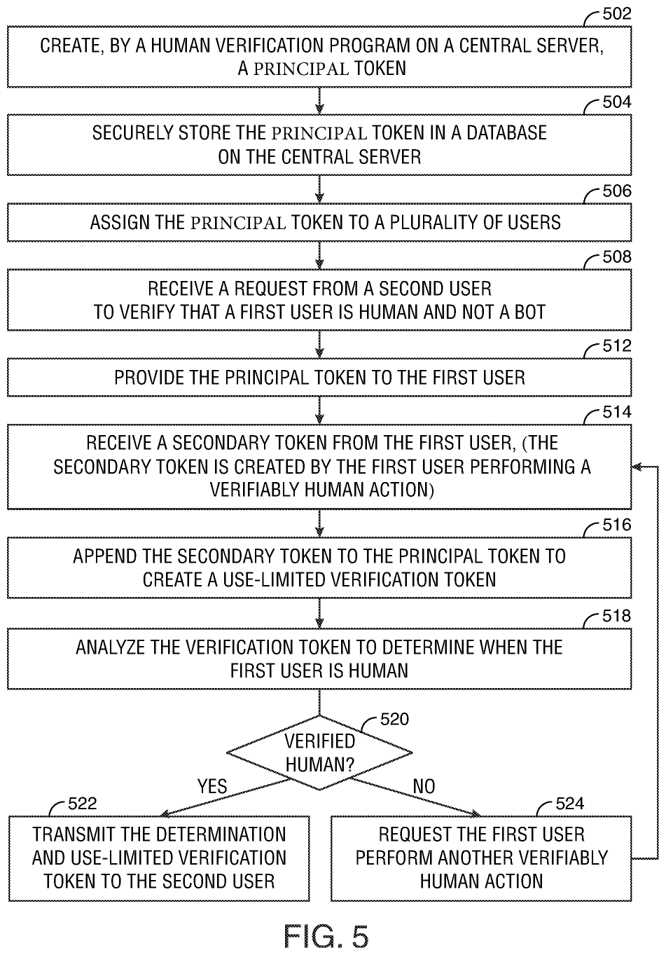

FIG. 5 shows an illustrative flowchart in accordance with principles of the disclosure. Methods may include some or all of the method steps numbered 502 through 524. Methods may include the steps illustrated in FIG. 5 in an order different from the illustrated order. The illustrative method shown in FIG. 5 may include one or more steps performed in other figures or described herein. Steps 502 through 524 may be performed on the apparatus shown in FIGS. 1-4, 6 or other apparatus.

At step 502, a human verification program on a centralized or decentralized server may create a principal token. The principal token may be encrypted. The principal token may be in alphanumeric characters.

At step 504, the human verification may securely store the principal token in a database. The database may be on the central server. The database may be distributed across multiple computers. The database may be a distributed ledger. The distributed ledger may be a blockchain.

At step 506, the human verification program may assign the principal token to a plurality of users, i.e., to the profiles of each of a plurality of users. Limiting each principal token to a plurality of users may assist in human verification.

At step 508, the human verification program may receive a request from a second user of the plurality of users to verify that a first user from the plurality of users is human. First and second may be interchangeable.

In an embodiment, the human verification program may be able to handle multiple requests from multiple users at the same time.

At step 512, in response to the request, the program may provide the principal token to the first user, i.e., the first user's computer. In an embodiment, the principal token may already be on the first user's computer and the program may send a request to the first user to perform a verifiably human action.

At step 514, in response to receiving the principal token (or, in an embodiment, the request), the first user may perform a verifiably human action, as defined in this disclosure. The verifiably human action may create a secondary token. The secondary token may then be transmitted to the human verification program. In an embodiment, the principal token may also be transmitted back to the human verification program, as part of a key or value exchange and handshake.

At step 516, the program may append or add secondary token to the principal token, to create a use-limited or time-limited verification token.

At step 518, the program may analyze the verification token to determine whether the first user is human or not. It may analyze, in an embodiment, by applying one or more artificial intelligence/machine learning (“AI/ML”) algorithms, to the secondary token. It may analyze to determine whether the secondary token data meets a pre-determined threshold level of accuracy and verification.

At step 520, the program may ask whether the first user has verified she is human or not.

If yes, at step 522, the program may transmit the determination and verification token to the second user, assuring the second user that the first user is human.

If no, in an embodiment, at step 524, the program may request the first user perform another verifiably human action, and then repeat steps 514-518. In another embodiment, the program may inform the second user that the first user is more likely than not an AI bot, or cannot be verified as a human.

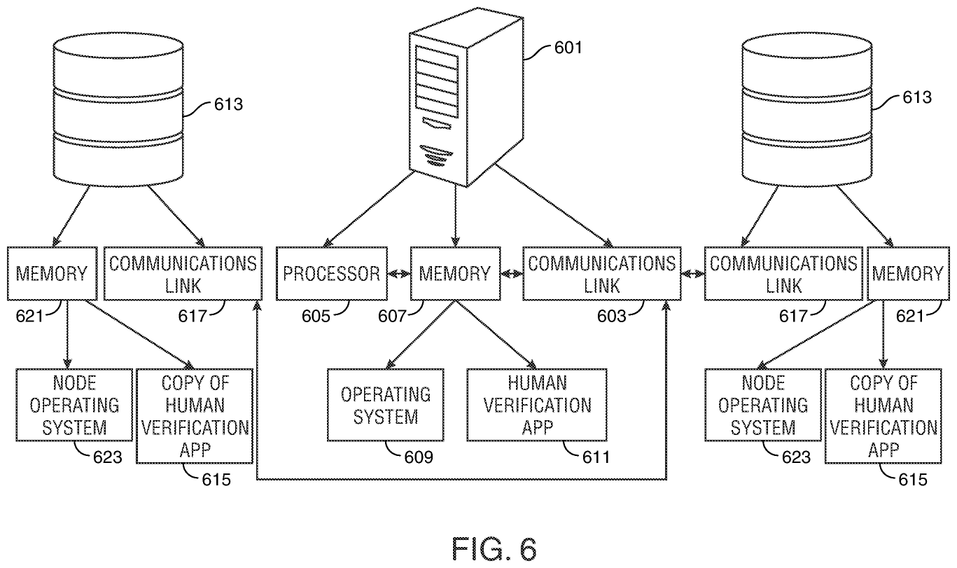

FIG. 6 shows an illustrative apparatus in accordance with principles of the disclosure. The apparatus may include a central server 601 and two or more nodes 613.

The central server 601 may include a server communications link 603, a server processor/processors 605, and a server non-transitory memory 607, as well as other components.

Each of the nodes 613 may include a node communications link 617, a node processor or processors, and a node non-transitory memory 621. Each node may be a computer, smart mobile device, server, or other computing device.

The server non-transitory memory 607 may include a server operating system 609, a human verification application 611, as well as other data and programs.

The server communications link 603 may communicate with each node 613 (as well as other servers/computers, not shown) through node communications link 617. The human verification program 611 may communicate with all nodes 613 through the server communications link 603.

Each node non-transitory memory 621 may include a node operating system 623, and a copy of the human verification program 615.

The human verification program 611 may create a principal token, securely store the principal token in a database on the central server 601 and assign the principal token to a plurality of users, wherein each user from the plurality of users has access to one of the network nodes 613.

When the human verification program 611 receives a request, over the communications link 603-617 from a second user from the plurality of users to verify that a first user from the plurality of users is human, it may provide the principal token to the first user over the communications link 603-617.

The human verification program 611 may receive a secondary token from the first user over the communications link 603-617. The secondary token may be created by the first user performing a verifiably human action on one of the two or more network nodes 613 through the copy of the human verification program 615.

The human verification program 611 may append the secondary token to the principal token to create a use-limited verification token.

The human verification program 611 may analyze the verification token to determine when the first user is human.

When the human verification program 611 determines that the first user is human, it may transmit the determination and the verification to the second user over the communications link 603-617.

Thus, apparatus and methods to verify that a user is human and not a bot through using digital tokens are provided. Persons skilled in the art will appreciate that the present invention can be practiced by other than the described embodiments, which are presented for purposes of illustration rather than of limitation.

What is claimed is:

1. A human verification computer program product, the computer program product comprising executable instructions, the executable instructions when executed by a processor on a computer system:
create a principal token;
securely store the principal token in a database;
assign the principal token to a plurality of users;
receive a request from a second user from the plurality of users to verify that a first user from the plurality of users is human;
provide the principal token to the first user;
receive a secondary token from the first user;
append the secondary token to the principal token to create a use-limited verification token;
analyze the verification token to determine when the first user is human; and
when the first user is determined to be human, transmit the determination to the second user;
wherein:
the secondary token is created by the first user performing a verifiably human action.

2. The human verification computer program product of claim 1 wherein the verifiably human action is responding to a captcha.

3. The human verification computer program product of claim 1 wherein the verifiably human action is measuring a parameter with a biometric sensor.

4. The human verification computer program product of claim 3 wherein the parameter is body temperature.

5. The human verification computer program product of claim 3 wherein the parameter is pulse rate.

6. The human verification computer program product of claim 1 wherein the verifiably human action is answering an arithmetic question incorrectly.

7. The human verification computer program product of claim 1 wherein the verifiably human action is placing a particular weight on a weight sensor electronically coupled to a transmitter.

8. The human verification computer program product of claim 1 wherein the verifiably human action is physically connecting two or more components to form an electrical circuit.

9. The human verification computer program product of claim 1 wherein the analysis applies one or more filtering rules to determine whether the first user is a human.

10. The human verification computer program product of claim 1 wherein the verifiably human action is typing a supplied random phrase.

11. The human verification computer program product of claim 10 wherein the analysis analyzes one or more of:
a) typing cadence;
b) typing speed;
c) typing accuracy;
d) key pressure; and
e) a combination of a)-d).

12. The human verification computer program product of claim 1 wherein the instructions delete the secondary token and verification token after transmitting the determination to the second user.

13. The human verification computer program product of claim 1 wherein the database is on a central server.

14. The human verification computer program product of claim 1 wherein the database is on a computer belonging to one of the plurality of users.

15. The human verification computer program product of claim 1 wherein the database is distributed on computers belonging to each of the plurality of users.

16. The human verification computer program product of claim 1 wherein the principal token is encrypted.

17. The human verification computer program product of claim 1 wherein plurality of users communicate through an internal network.

18. The human verification computer program product of claim 1 wherein the plurality of users is between two and ten users.

19. An apparatus for human verification, the apparatus comprising:
a central server, the central server including:
a server communication link;
a server processor; and
a server non-transitory memory configured to store at least:
a server operating system; and
a human verification application; and
two or more network nodes, each network node comprising:
a node communication link;
a node processor; and
a node non-transitory memory configured to store at least:
a node operating system; and
a copy of the human verification application;
wherein the human verification application:
creates a principal token;
securely stores the principal token in a database on the central server;
assigns the principal token to a plurality of users,
wherein each user from the plurality of users has access to one network node;
receives a request from a second user from the plurality of users to verify that a first user from the plurality of users is human;
provides the principal token to the first user;
receives a secondary token from the first user, wherein the secondary token is created by the first user performing a verifiably human action on one of the two or more network nodes;
appends the secondary token to the principal token to create a use-limited verification token;
analyzes the verification token to determine when the first user is human; and
when the first user is determined to be human, transmits the determination to the second user.

20. A method for human verification, the method comprising the steps of:
creating, by a human verification program on a central server, a principal token;
securely storing the principal token in a database on the central server;
assigning the principal token to a plurality of users;
receiving a request from a second user from the plurality of users to verify that a first user from the plurality of users is human;
providing the principal token to the first user;
receiving a secondary token from the first user, wherein the secondary token is created by the first user performing a verifiably human action;
appending the secondary token to the principal token to create a use-limited verification token;
analyzing the verification token to determine when the first user is human; and
when the first user is determined to be human, transmitting the determination and use-limited verification token to the second user.
